(19) United States
(12) Patent Application Publication
(10) Pub. No.: US 2017/0052793 A1
(43) Pub. Date: Feb. 23, 2017

(54) AUTOMATIC APPLICATION CONTROL SYSTEM, AUTOMATIC APPLICATION CONTROL METHOD, AND PROGRAM RECORDING MEDIUM

(71) Applicant: NEC Corporation, Tokyo (JP)

(72) Inventor: Hiroki MATSUKANE, Tokyo (JP)

(73) Assignee: NEC Corporation, Tokyo (JP)

(21) Appl. No.: 15/306,970

(22) PCT Filed: May 7, 2015
(86) PCT No.: PCT/JP2015/002318

§ 371 Date: Oct. 26, 2016

(30) Foreign Application Priority Data
May 9, 2014 (JP) 2014-097601

(51) Int. Cl. G06F 9/445

(52) U.S. Cl. CPC G06F 9/445

(57) ABSTRACT

In order to enable automatic control of setting of an application depending on a surrounding environment in which the application is used, the present invention is provided with a communication terminal that includes: a terminal operation information processing means that collects and stores terminal operation information including an application name of an activated application and surrounding environment information including an activation time and an activation location; a first application operation information processing means that acquires application operation information of the application, and stores the acquired application operation information and the terminal operation information in association with each other; and an application control means that acquires the application operation information associated with the terminal operation information of the activated application, and performs setting of the application on the basis of the acquired application operation information.

### TECHNICAL FIELD

The present invention relates to an automatic application control system, an automatic application control method, and a program recording medium for automatically controlling an activated application. More specifically, the present invention relates to an automatic application control system, an automatic application control method, and a program recording medium for automatically controlling an application by cooperation between a communication terminal and a server.

### BACKGROUND ART

Nowadays, mobile terminal devices such as mobile phones, smartphones, notebook personal computers, tablet computers, portable game consoles, and PDAs (Personal Digital Assistants) are spread. A variety of applications are loaded in the terminal devices according to purposes of use.

Among a variety of applications loaded in terminal devices, some applications require to input settings or change settings depending on a surrounding environment such as a time and a location where the applications are used. However, when an application is manually set accompanied by a change in the surrounding environment, if the user of the terminal device inadvertently forgets to perform setting of the application, the setting of the application may become inappropriate. For instance, when the user leaves the sound volume setting of an application extremely large, in activating the application with which the user listens to music in a train, music may be output with a large sound volume. This may annoy the passengers nearby.

Further, changing settings of an application each time the surrounding environment changes is inconvenient to a user using the application.

PTL 1 discloses a mobile terminal device which enables to store usage patterns of applications by the user, and to display an operation menu depending on the situation. The mobile terminal device disclosed in PTL 1 also provides an application presentation function associated with a moving direction of the terminal device, in addition to position information of the terminal device.

### CITATION LIST

### Patent Literature

[PTL 1] Japanese Laid-open Patent Publication No. 2012-216987

### SUMMARY OF INVENTION

### Technical Problem

Generally, in an application which requires to input settings or change settings depending on a surrounding environment, there is a problem that it is necessary to manually input settings or change settings of the application, each time the surrounding environment changes. Further, there is also a problem that if the user inadvertently forgets to perform the setting of an application, the setting of the application may be inappropriate depending on the surrounding environment.

In the mobile terminal device disclosed in PTL 1, it is possible to automatically activate an application depending on position information or a moving direction of the terminal device. However, in an application which requires to input settings or change settings depending on the surrounding environment, there is yet a problem that it is necessary to manually input settings or change settings of the application.

An object of the present invention is to provide an automatic application control system that enables to automatically control setting of an application depending on a surrounding environment of the application.

### Solution to Problem

An automatic application control system of the present invention is provided with a communication terminal that includes: a terminal operation information processing means that collects and stores terminal operation information including an application name of an activated application and surrounding environment information including an activation time and an activation location; a first application operation information processing means that acquires application operation information of the application, and stores the acquired application operation information and the terminal operation information in association with each other; and an application control means that acquires the application operation information associated with the terminal operation information of the activated application, and performs setting of the application on the basis of the acquired application operation information.

An automatic application control method of the present invention includes: collecting terminal operation information including an application name of an activated application and surrounding environment information including an activation time and an activation location; acquiring application operation information of the application; storing the acquired application operation information and the terminal operation information in association with each other; acquiring the application operation information associated with the terminal operation information of the activated application; and performing setting of the application on the basis of the acquired application operation information.

A program recording medium of the present invention records an automatic application control program that causes a computer to execute: a process of collecting terminal operation information including an application name of an activated application and surrounding environment information including an activation time and an activation location; a process of acquiring application operation information of the application; a process of storing the acquired application operation information and the terminal operation information in association with each other; a process of acquiring the application operation information associated with the terminal operation information of the activated application; and a process of performing setting of the application on the basis of the acquired application operation information.

### Advantageous Effects of Invention

According to the present invention, it is possible to provide an automatic application control system which extracts application operation information depending on a surrounding environment of an activated application, and which sets the application on the basis of the extracted application operation information.

### BRIEF DESCRIPTION OF DRAWINGS

FIG. 1 is a block diagram illustrating a functional configuration of an automatic application control system according to an example embodiment of the present invention;

FIG. 2 is a block diagram illustrating a functional configuration of a communication terminal in the automatic application control system according to the example embodiment of the present invention;

FIG. 3 is a block diagram illustrating a functional configuration of a server in the automatic application control system according to the example embodiment of the present invention;

FIG. 4 is a table illustrating an example of a terminal operation information log table to be used in the automatic application control system according to the example embodiment of the present invention;

FIG. 5 is a table illustrating an example of a database information table to be used in the automatic application control system according to the example embodiment of the present invention;

FIG. 6 is a flowchart for describing an operation of the communication terminal in the automatic application control system according to the example embodiment of the present invention;

FIG. 7 is a flowchart for describing an operation of the communication terminal in the automatic application control system according to the example embodiment of the present invention;

FIG. 8 is a flowchart for describing an operation of the server in the automatic application control system according to the example embodiment of the present invention;

FIG. 9 is a sequence diagram for describing an operation of the automatic application control system according to the example embodiment of the present invention;

FIG. 10 is a sequence diagram for describing an operation of the automatic application control system according to the example embodiment of the present invention;

FIG. 11 is a sequence diagram for describing an operation of the automatic application control system according to the example embodiment of the present invention;

FIG. 12 is a sequence diagram for describing an operation of the automatic application control system according to the example embodiment of the present invention;

FIG. 13 is a block diagram illustrating an example of a hardware configuration for implementing the communication terminal in the automatic application control system according to the example embodiment of the present invention; and

FIG. 14 is a block diagram illustrating an example of a hardware configuration for implementing the server in the automatic application control system according to the example embodiment of the present invention.

### DESCRIPTION OF EMBODIMENTS

In the following, an example embodiment for implementing the present invention is described using the drawings. Note that in the example embodiment to be described in the following, technically preferred limitations for implementing the present invention are described. The scope of the present invention, however, is not limited to the following.

An automatic application control system according to the example embodiment includes a communication terminal as represented by a mobile phone or a smartphone, and a server which notifies setting information for each application depending on a location or a time when the user uses an application. cl Example Embodiment

(Configuration)

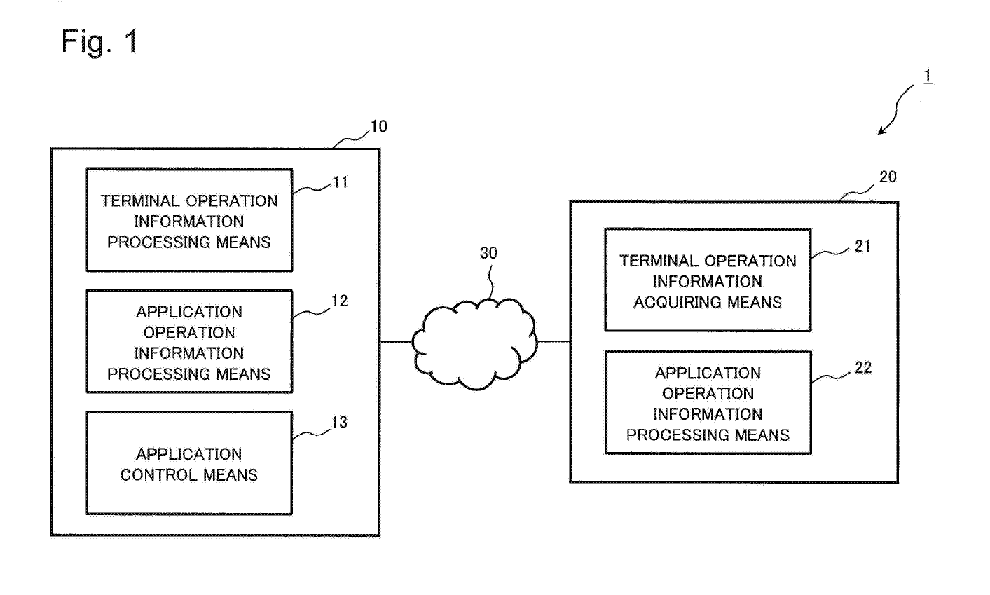

First of all, a configuration of an automatic application control system 1 according to an example embodiment of the present invention is described referring to FIG. 1 to FIG. 3.

As illustrated in FIG. 1, the automatic application control system 1 according to the example embodiment of the present invention includes a communication terminal 10 and a server 20. The communication terminal 10 and the server 20 are connected via a network 30. Note that the network 30 may be an external network such as the Internet, or may be an intranet such as a local area network, or may be a network in which a plurality of communication patterns are combined.

(Communication Terminal)

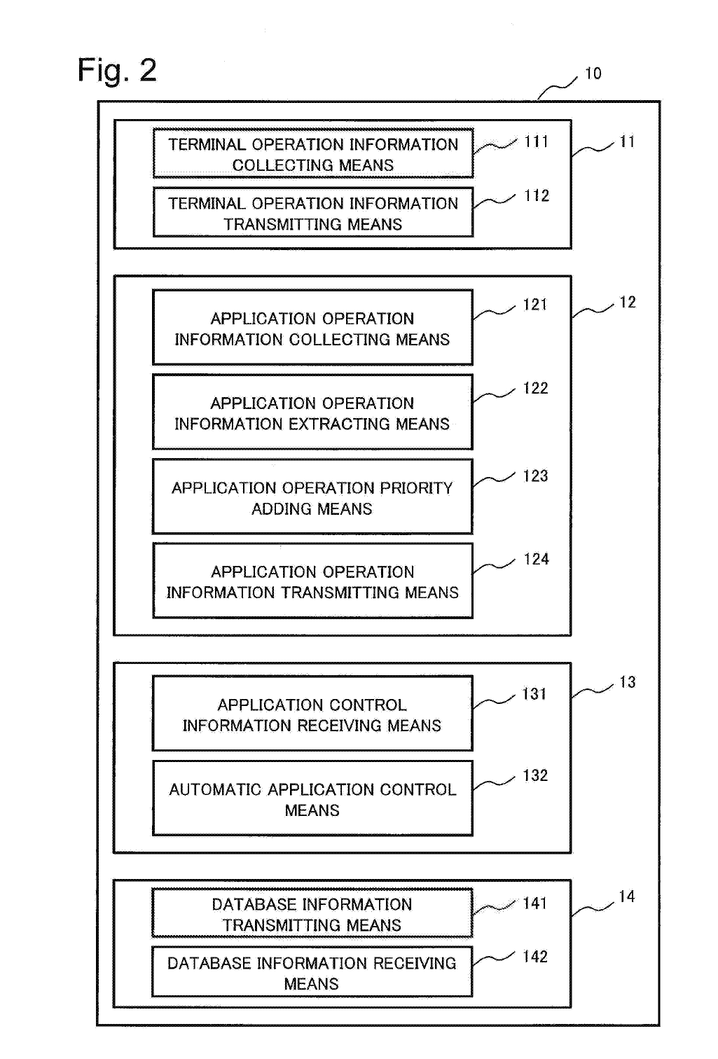

Next, a configuration of the communication terminal 10 in the automatic application control system 1 according to the example embodiment of the present invention is described referring to FIG. 1 and FIG. 2.

As illustrated in FIG. 1, the communication terminal 10 according to the example embodiment includes a terminal operation information processing means 11, an application operation information processing means 12, and an application control means 13. Further, as illustrated in FIG. 2, the communication terminal 10 may include a database 14 (also referred to as a first database).

The terminal operation information processing means 11 collects application names, activation locations, and activation times when the user activates applications of the communication terminal 10, and stores and transmits the collected terminal operation information (also referred to as a communication terminal operation log). In the example embodiment, application names of activated applications, activation locations, and activation times are referred to as terminal operation information. For instance, it is assumed that the user activates an application for use in listening to music (hereinafter, a music application) at 08:05 a.m. at a station. In this case, information such that the application name: music application, the activation time: 08:05 a.m., and the activation location: station corresponds to terminal operation information.

Application names to be included in terminal operation information may not necessarily completely match with each other. For instance, when a version of a target application is included in the application name, and a main part of the application name other than the version matches, it is possible to set such that the target application is the same. For instance, when the name of the target application is updated from “music application ver. 1” to “music application ver. 2” by version updating, the part “music application” may be judged as the application name. Note that when the version itself is necessary for specifying the application name, this is not the case. It is possible to arbitrarily set to what extent it is judged that the application names are the same.

It is possible to set an activation time to be included in terminal operation information with a certain margin of time. For instance, when the activation time is 07:00 a.m., it is possible to set such that a time within 10 minutes earlier or later than the activation time is regarded as the same activation time. Further, for instance, when the activation time is 07:00 a.m., it is possible to set such that a time zone from 07:00 a.m. to 07:30 a.m. is regarded as the same activation time. It is possible to arbitrarily set a time, which is regarded as a same activation time, by a system setting or by a user setting.

It is possible to set an activation location to be included in terminal operation information with a certain range. For instance, when the activation location is a station, it is possible to set such that a 10-meter area from the station is regarded as the same activation location. It is possible to arbitrarily set an area, which is regarded as a same activation location, by a system setting or by a user setting. Regarding an activated application, terminal operation information serves as a key for extracting setting information of an application depending on a surrounding environment.

For instance, position information is acquired by a device having a GPS (Global Positioning System) function. For instance, position information may be acquired by using position information or the like acquired from a base station to be wirelessly connected, from an access point, or from the network 30. Further, position information to be measured by a gyro sensor or a magnetic sensor within the communication terminal 10 may be used on the basis of position information acquired at a specific point of time. For instance, when position information is acquired by a GPS or the like, position information of the communication terminal 10 may be associated with specific facility information or the like by a software for mapping the acquired position information on a map.

Further, for instance, incorporating an acceleration sensor or a magnetic sensor in the communication terminal 10, and analyzing speed information measured by the sensor of the communication terminal 10 and position information acquired from a GPS make it possible to determine that the communication terminal 10 is in a moving body such as a train or an automobile. For instance, when the communication terminal 10 is in a moving body, it is possible to specify in what moving body the communication terminal 10 is by software for analyzing position information of the communication terminal 10 to be acquired by a GPS, and speed information of the communication terminal 10 to be acquired by a sensor.

Further, for instance, it is also possible to specify position information indicating the presence of the connected communication terminal 10 by an access point of a wireless LAN (Local Area Network) in a building or in a moving body. For instance, associating an identification number such as an IP (Internet Protocol) address set for a device as an access point with position information makes it possible to specify a location where the communication terminal 10 is connected to a network by the IP address.

The application operation information processing means 12 (also referred to as a first application operation information processing means) collects application operation information, and performs a process of extracting and transmitting application operation information, and adding an application operation priority depending on the situation.

Application operation information indicates information set by the user with respect to an activated application. Application operation information is associated with terminal operation information of an activated application. For instance, when a target application is an application for use in listening to music, setting information such as music selected by the user or a set sound volume in an activated application corresponds to application operation information. Further, for instance, when the user activates a news browser application, and browses a sports article, the URL (Uniform Resource Locator) of a browsed sports article serves as application operation information. Note that when the URL differs between the articles browsed by a news browser application, a latest article out of the target articles, or an article whose access number is large, may be set as application operation information.

An application operation priority indicates a priority in an application operation by the user. When there are a plurality of application operation information items associated with terminal operation information of an activated application, an application operation priority serves as an index as to which one of the application operation information items is to be set.

An application operation priority is expressed by a numerical value of 1 or larger, and is added by 1 each in association with an application name, an activation time, and an activation location (terminal operation information), each time the user performs an application operation on the communication terminal 10. Application operation information whose application operation priority is higher is preferentially set. Specifically, application operation information whose application operation priority is high is extracted, while using terminal operation information of an activated application as a key, and the extracted application operation information is set in the target application.

Application operation priorities are compared between application operation information items associated with a surrounding environment of a same application. In the example embodiment, when there are a plurality of application operation information items to be stored in the database 14 on the basis of an application name activated by the user on the communication terminal, a time and a location (terminal operation information), application operation priorities are compared with each other. Then, the application operation information processing means 12 extracts application operation information whose application operation priority is high, and sets the extracted application operation information in the communication terminal 10.

The application control means 13 acquires application operation information depending on a surrounding environment of the communication terminal 10 (user), and performs setting of an application on the basis of the acquired application operation information. Specifically, the application control means 13 extracts application setting information to be stored in the database 14, while using an application name activated on the communication terminal 10, an activation time, and an activation location as a key. Then, the application control means 13 sets the extracted application operation information in the communication terminal 10. Note that a surrounding environment is a time and a location where an application is activated. Further, information including an activation time and an activation location of an application is also referred to as surrounding environment information.

The database 14 stores, transmits, and receives terminal operation information, application operation information, and application operation priorities. Note that terminal operation information, application operation information, and application operation priorities are referred to as database information. Further, storing changed or added information in a database in changing or adding information to be included in database information is also referred to as updating database information.

Next, an internal configuration of each of the constituent elements of the communication terminal 10 is described.

### Terminal Operation Information Processing Means

The terminal operation information processing means 11 includes a terminal operation information collecting means 111 and a terminal operation information transmitting means 112.

The terminal operation information collecting means 111 collects terminal operation information of an activated application when the user activates the application of the communication terminal 10. The terminal operation information collecting means 111 includes a function of acquiring position information and time information, and collects a location and a time when an application is activated, as terminal operation information associated with the application name of the activated application. The terminal operation information collecting means 111 stores collected terminal operation information when the collected terminal operation information is not stored in the communication terminal. Note that the storage destination of terminal operation information may be the terminal operation information collecting means 111, or an unillustrated storage means, or an unillustrated database.

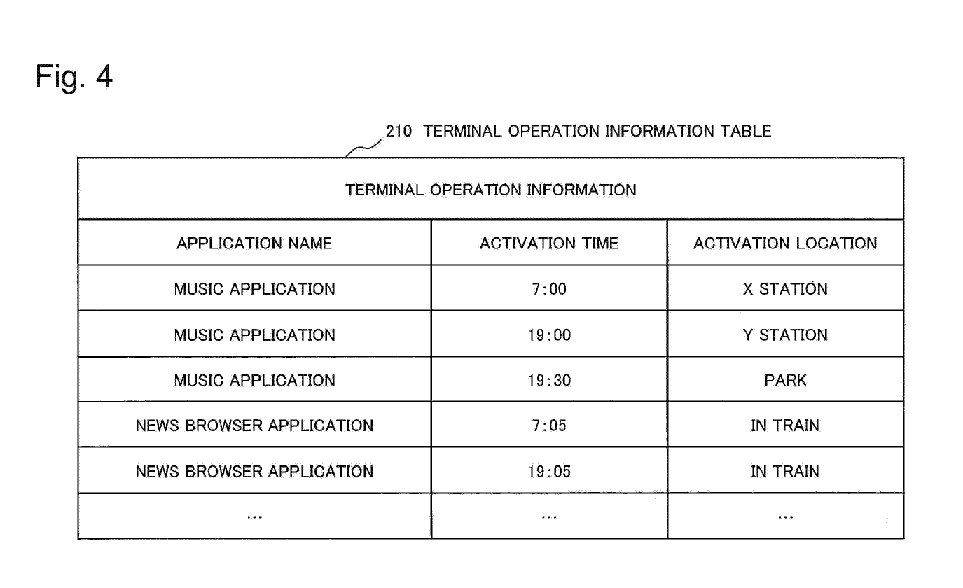

For instance, terminal operation information may be stored in a table format. FIG. 4 illustrates an example of a terminal operation information table 210 in which terminal operation information is recorded. Communication terminal information including the application names of activated applications, activation times, and activation locations is registered in the terminal operation information table 210.

FIG. 4 illustrates an example, in which terminal operation information including activation times and activation locations is registered regarding a news browser application and a music application.

For instance, it is assumed that the user of the communication terminal 10 arrives at X station near his/her home at 07:00 every morning, and takes a train at 07:05. Further, it is assumed that the user arrives at Y station near his/her office at 19:00, takes a train at 19:05, gets off the train at 19:30, and walks back home. In FIG. 4, terminal operation information is registered depending on each time and each location. Specifically, regarding the music application, there are three terminal operation information items “music application: 07:00, X station”, “music application: 19:00, Y station”, and “music application: 19:30, park”. Likewise, regarding the news browser application, there are two terminal operation information items “news browser application: 07:05, in the train” and “news browser application: 19:05, in the train”.

Note that the terminal operation information table 210 illustrated in FIG. 4 is an example, and does not limit the scope of the present invention. Further, terminal operation information may not be necessarily registered in a table format, but may be registered as a set of the application name of a target application, an activation time, and an activation location.

The terminal operation information transmitting means 112 transmits terminal operation information acquired by the terminal operation information collecting means 111 to the server 20. For instance, the terminal operation information transmitting means 112 is implemented by an interface connected to the server 20 via the network 30.

### Application Operation Information Processing Means

The application operation information processing means 12 includes an application operation information collecting means 121, an application operation information extracting means 122, an application operation priority adding means 123, and an application operation information transmitting means 124.

The application operation information collecting means 121 collects application operation information as operation information within an application by the user. The application operation information collecting means 121 stores collected application operation information in association with terminal operation information.

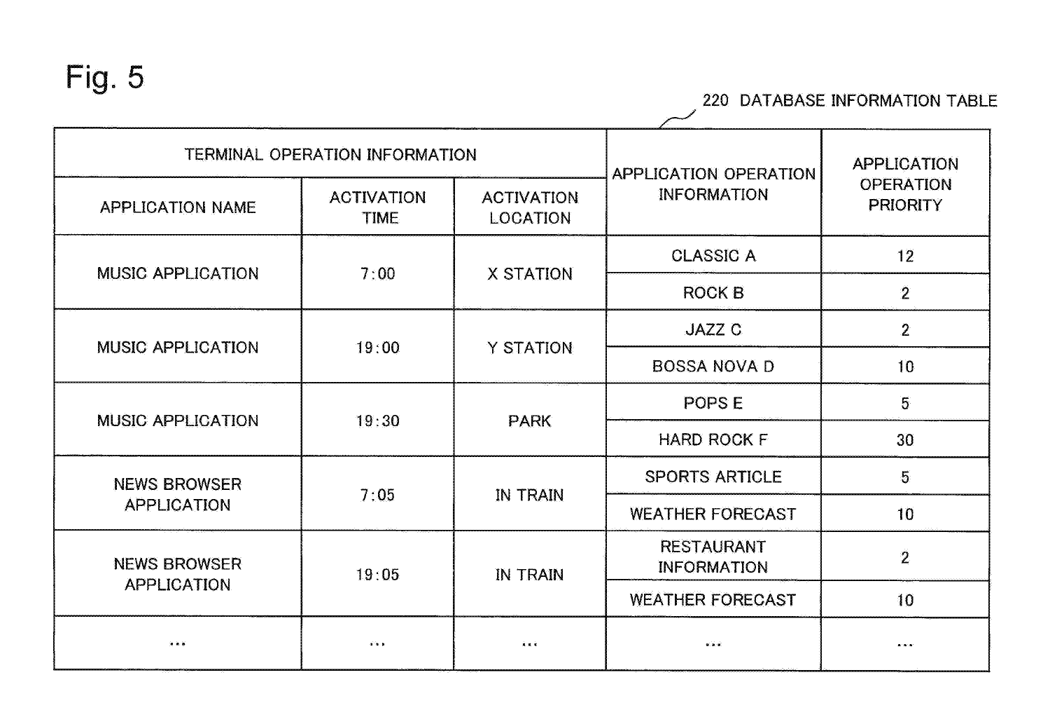

For instance, the application operation information collecting means 121 stores application operation information in association with terminal operation information in a table format as exemplified by a database information table 220 illustrated in FIG. 5.

In this case, an example is described, in which terminal operation information is such that a news browser application is activated in a train at 07:05, and an application priority is accumulated when the user browses a sports article on a day, and browses a weather forecast article on another day. According to the database information table 220 illustrated in FIG. 5, an application operation priority is added for each application setting information item. According to the database information table 220 illustrated in FIG. 5, the application operation priority of a weather forecast article is higher than a sports article. Therefore, when the news browser application is activated in the train at 07:05, a weather forecast article is set as application setting information. Regarding the other application operation information items registered in the database information table 220 illustrated in FIG. 5, the same operation as described above is applied.

According to the database information table 220 illustrated in FIG. 5, when the user activates the music application at 07:00 at X station, classic music A is selected. It is assumed that the music application is activated at 19:30 in the park last time. When the user activates the music application at 19:00 at X station, it is presumed that setting suitable for listening to hard rock music F is performed. When the user sets a large sound volume in listening to hard rock music F, and if the music application is activated at 07:00 while keeping the sound volume setting unchanged, sound may leak to the outside. In the example embodiment, when the music application is activated at 07:00 at X station, sound leakage to the outside does not occur, because classic music A is selected on the basis of application operation information. Normally, changing settings of an application is performed by the user before the application is shut down or after the application is activated. However, setting of an application may not be securely performed each time an application is shut down or activated. In the method according to the example embodiment, appropriate setting of an application is securely performed depending on an activation time and an activation location of an activated application.

The application operation information extracting means 122 extracts application operation information whose application operation priority is highest regarding activation locations and activation times of applications, while using the application names as a key.

The application operation priority adding means 123 adds an application operation priority of application operation information depending on the situation.

The application operation information transmitting means 124 transmits application operation information to the server 20.

### Application Control Means The application control means 13 includes an application control information receiving means 131 and an automatic application control means 132.

The application operation information receiving means 131 receives notification of application operation information depending on a surrounding environment from the server 20.

The automatic application control means 132 performs automatic setting of an application within the communication terminal 10 on the basis of application operation information extracted from the communication terminal 10 or received from the server 20. Note that automatic setting of an application is setting parameters in a target application on the basis of application operation information.

### Database

The database 14 includes a database information transmitting means 141 and a database information receiving means 142.

The database information transmitting means 141 transmits database information stored in the communication terminal 10 to the server 20.

The database information receiving means 142 receives database information from the server 20 and stores the received database information.

The foregoing is a description about a configuration of the communication terminal 10 according to the example embodiment.

(Server)

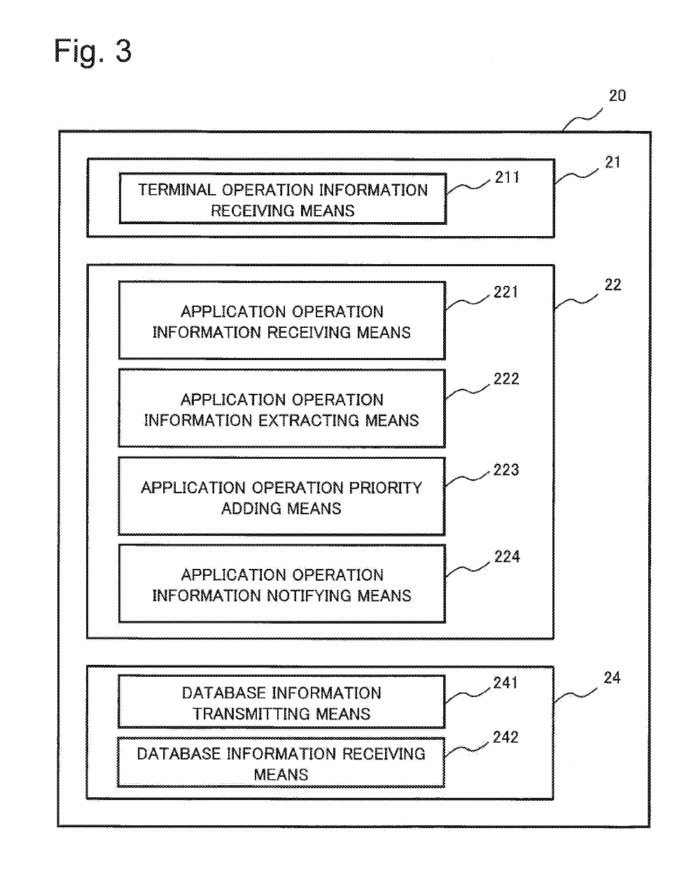

Next, a functional configuration of a server in the automatic application control system according to the example embodiment of the present invention is described referring to FIG. 1 and FIG. 3.

As illustrated in FIG. 1, the server 20 includes a terminal operation information acquiring means 21 and an application operation information processing means 22. Further, as illustrated in FIG. 3, the server 20 may include a database 24 (also referred to as a second database).

The terminal operation information acquiring means 21 receives terminal operation information transmitted from the communication terminal 10, and stores the received terminal operation information depending on the situation.

The application operation information processing means 22 (also referred to as a second application operation information processing means) receives application operation information. Further, the application operation information processing means 22 performs a process of extracting and transmitting application operation information, and adding an application operation priority of application operation information depending on the situation.

The database 24 stores database information, and transmits and receives database information.

Next, an internal configuration of each of the constituent elements of the server 20 is described.

### Terminal Operation Information Acquiring Means

The terminal operation information acquiring means 21 includes a terminal operation information receiving means 211.

The terminal operation information receiving means 211 receives terminal operation information transmitted from the terminal operation information transmitting means 112 of the communication terminal 10. When received terminal operation information is not stored in the server 20, the terminal operation information receiving means 211 stores the received terminal operation information.

### Application Operation Information Processing Means

The application operation information processing means 22 includes an application operation information receiving means 211, an application operation information extracting means 222, an application operation priority adding means 223, and an application operation information notifying means 224.

The application operation information receiving means 221 receives application operation information from the communication terminal 10. The application operation information receiving means 221 stores received application operation information in association with terminal operation information.

When received terminal operation information is already stored, the application operation information extracting means 222 extracts application operation information whose application operation priority is highest regarding activation locations and activation times of applications, while using the application names as a key.

The application operation priority adding means 223 adds an application operation priority of application operation information.

The application operation information notifying means 224 transmits application operation information extracted by the application operation information extracting means 222 to the communication terminal 10. Then, when the application operation information notifying means 224 does not receive application operation information from the communication terminal 10 for a predetermined period of time, the application operation information notifying means 224 outputs an instruction to add an application operation priority of transmitted application operation information to the application operation priority adding means 223.

### Database

The database 24 includes a database information transmitting means 241 and a database information receiving means 242. The database 24 may be configured in the communication terminal 10, and in a storage means such as a main storage device or an auxiliary storage device inside the server 20.

The database information transmitting means 241 transmits database information stored in the server 20 to the communication terminal 10.

The database information receiving means 242 receives database information from the communication terminal 10 and stores the received database information.

The foregoing is a description about a configuration of the automatic application control system according to the example embodiment of the present invention.

(Operations)

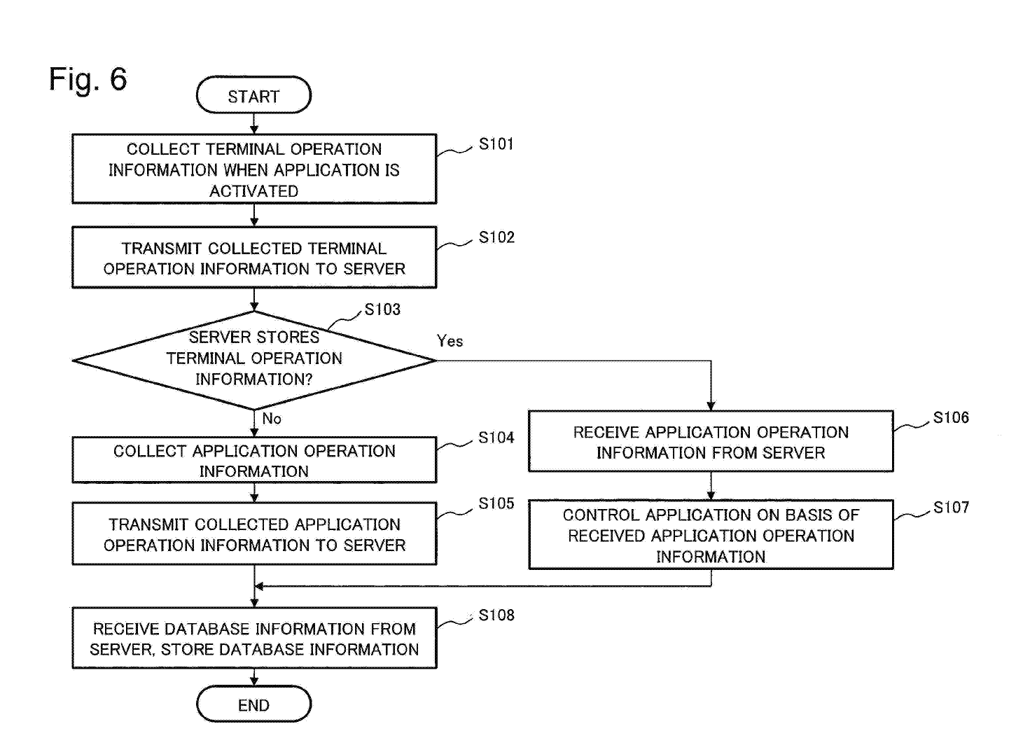

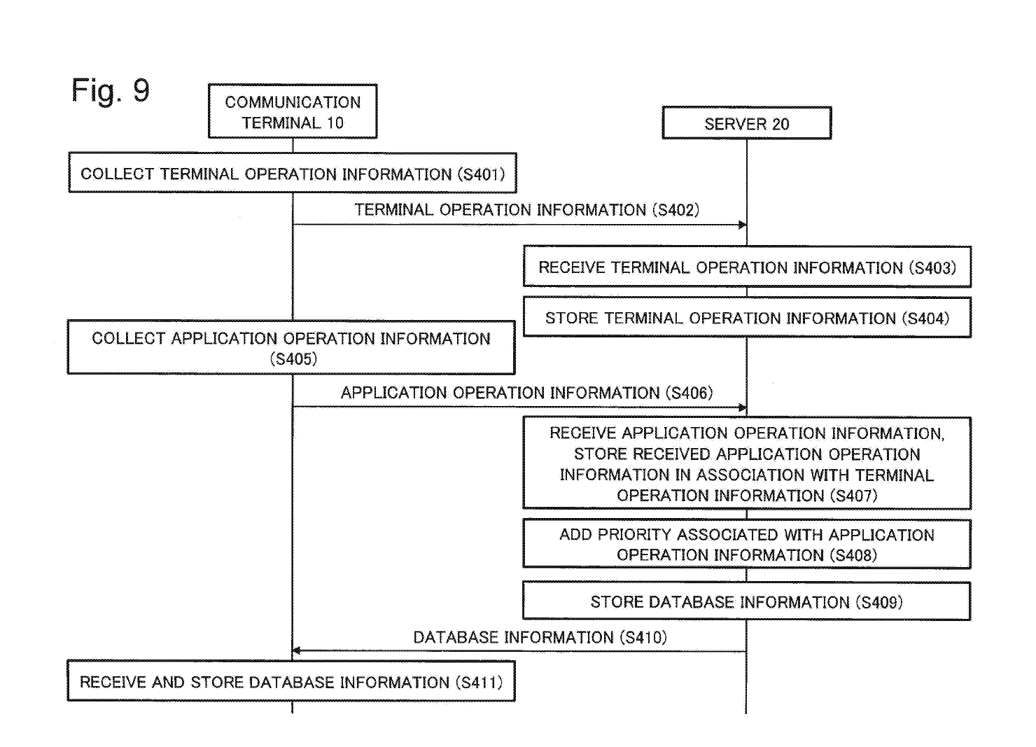

Next, an operation of the automatic application control system 1 according to the example embodiment of the present invention is described referring to FIG. 6 to FIG. 12. FIG. 6 to FIG. 8 are flowcharts relating to each of the operations of the communication terminal 10 and the server 20. FIG. 9 to FIG. 12 are sequence diagrams for associating the operations of the communication terminal 10 and the server 20 with each other.

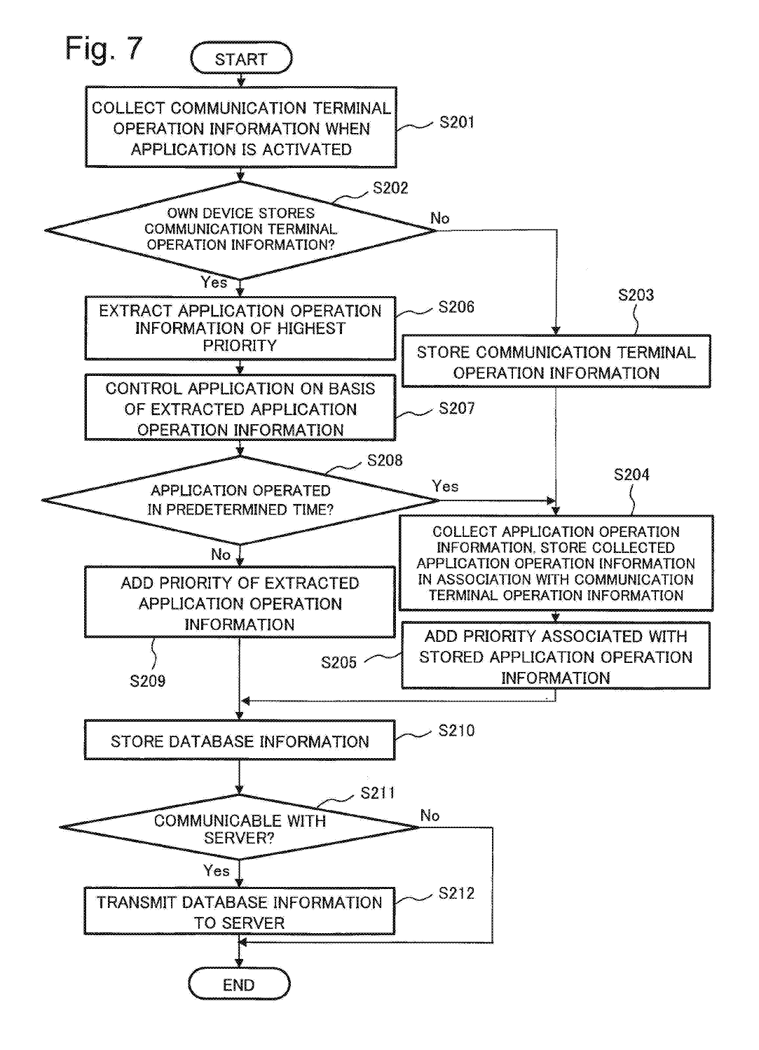

First of all, an operation of the communication terminal 10 is described referring to the flowcharts of FIG. 6 and FIG. 7. Note that FIG. 6 relates to a case, in which the communication terminal 10 is within a communication range with respect to the server 20, and FIG. 7 relates to a case, in which the communication terminal 10 is outside a communication range with respect to the server 20.

### Communication Terminal: Within Communication Range

First of all, a case is described, in which the communication terminal 10 is within a communication range with respect to the server 20.

In FIG. 6, first of all, when the user activates an application within the communication terminal 10, the terminal operation information collecting means 111 collects terminal operation information (Step S101).

The terminal operation information transmitting means 112 transmits terminal operation information collected by the terminal operation information collecting means 111 to the server 20 (Step S102).

In this example, the communication terminal 10 performs different operations depending on whether or not the server 20 stores received terminal operation information (Step S103).

Firstly, a case is described, in which the server 20 does not store received terminal operation information (No in Step S103). The application operation information collecting means 121 collects application operation information operated by the user within the application (Step S104).

The application operation information transmitting means 124 transmits application operation information collected by the application operation information collecting means 121 to the server 20 (Step S105).

Then, the database receiving means 142 receives database information from the server 20 and stores the received database information (Step S108).

Secondly, a case is described, in which terminal operation information received by the server 20 is stored in the server 20 (Yes in Step S103). The application control information receiving means 131 receives application operation information from the server 20 (Step S106).

The automatic application control means 132 controls the application within the communication terminal 10 on the basis of application operation information received by the application control information receiving means 131 (Step S107).

Then, the database receiving means 142 receives database information from the server 20 and stores the received database information (Step S108).

The foregoing is a description about an operation of the communication terminal 10 when the communication terminal of the automatic application control system according to the example embodiment is within a communication range with respect to a server.

### Communication Terminal: Outside Communication Range

Next, a case is described, in which the communication terminal 10 is outside a communication range with respect to the server 20.

Referring to FIG. 7, first of all, when the user activates the application within the communication terminal 10, the terminal operation information collecting means 111 collects terminal operation information (Step S201).

In this example, the communication terminal 10 performs different operations depending on whether or not terminal operation information is stored in the own device (communication terminal 10) (Step S202).

Firstly, a case is described, in which terminal operation information is not stored in the own device (No in Step S202). The application operation information collecting means 121 collects application operation information operated by the user within the application, and stores the collected application operation information (Step S203).

The application operation information collecting means 121 collects application operation information as operation information by the user within the application, and stores the collected application operation information in association with terminal operation information (Step S204).

Then, the application operation priority adding means 123 adds an application operation priority of associated application operation information (Step S205).

After Step S205, the database information receiving means 142 stores database information (Step S210).

In this example, when the communication terminal 10 is operative to communicate with the server 20 (Yes in Step S211), the communication terminal 10 transmits database information to the server 20 (Step S212). Then, the flow illustrated in FIG. 7 is terminated. On the other hand, when the communication terminal 10 is inoperative to communicate with the server 20 (No in Step S211), the flow illustrated in FIG. 7 is terminated as it is. Note that when a judgment result in Step S211 is No, a step (Step S211) of judging whether or not the communication terminal 10 is operative to communicate with the server 20 again may be repeated at a predetermined time interval, or synchronization between the communication terminal 10 and the server 20 may be performed at a predetermined time interval.

Secondly, a case is described, in which terminal operation information is stored in the own device (Yes in Step S202). The application operation information extracting means 122 extracts application operation information whose application operation priority is highest regarding activation locations and activation times of applications, while using the application names as a key (Step S206).

The automatic application control means 132 controls the application within the communication terminal 10 on the basis of application operation information extracted by the application operation information collecting means 121 (Step S207).

In this example, the communication terminal 10 performs different operations depending on whether or not the application is operated within a predetermined period of time after automatic application control is executed (Step S208).

When the application is not operated within a predetermined period of time (No in Step S208), the application operation priority adding means 123 adds an application operation priority of extracted application operation information (Step S209).

After Step S209, the database information receiving means 142 stores database information (Step S210).

In this example, when the communication terminal 10 is operative to communicate with the server 20 (Yes in Step S211), the communication terminal 10 transmits database information to the server 20 (Step S212). Then, the flow illustrated in FIG. 7 is terminated. On the other hand, when the communication terminal 10 is inoperative to communicate with the server 20 (No in Step S211), the flow illustrated in FIG. 7 is terminated as it is.

On the other hand, when the application is operated within a predetermined period of time (Yes in Step S208), the flow proceeds to Step S204. Specifically, the application operation information collecting means 121 collects application operation information as operation information by the user within the application, and stores the collected application operation information in association with terminal operation information (Step S204).

Then, the application operation priority adding means 123 adds an application operation priority of associated application operation information (Step S205).

After Step S205, the database information receiving means 142 stores database information (Step S210).

In this example, when the communication terminal 10 is operative to communicate with the server 20 (Yes in Step S211), the communication terminal 10 transmits database information to the server 20 (Step S212). Then, the flow illustrated in FIG. 7 is terminated.

On the other hand, when the communication terminal 10 is inoperative to communicate with the server 20 (No in Step S211), the flow illustrated in FIG. 7 is terminated as it is. In this case, the database receiving means 242 of the server 20 receives database information transmitted from the communication terminal 10 and stores the received database information.

The foregoing is a description about an operation of the communication terminal 10 when the communication terminal 10 of the automatic application control system 1 according to the example embodiment is outside a communication range with respect to the server 20.

### Server

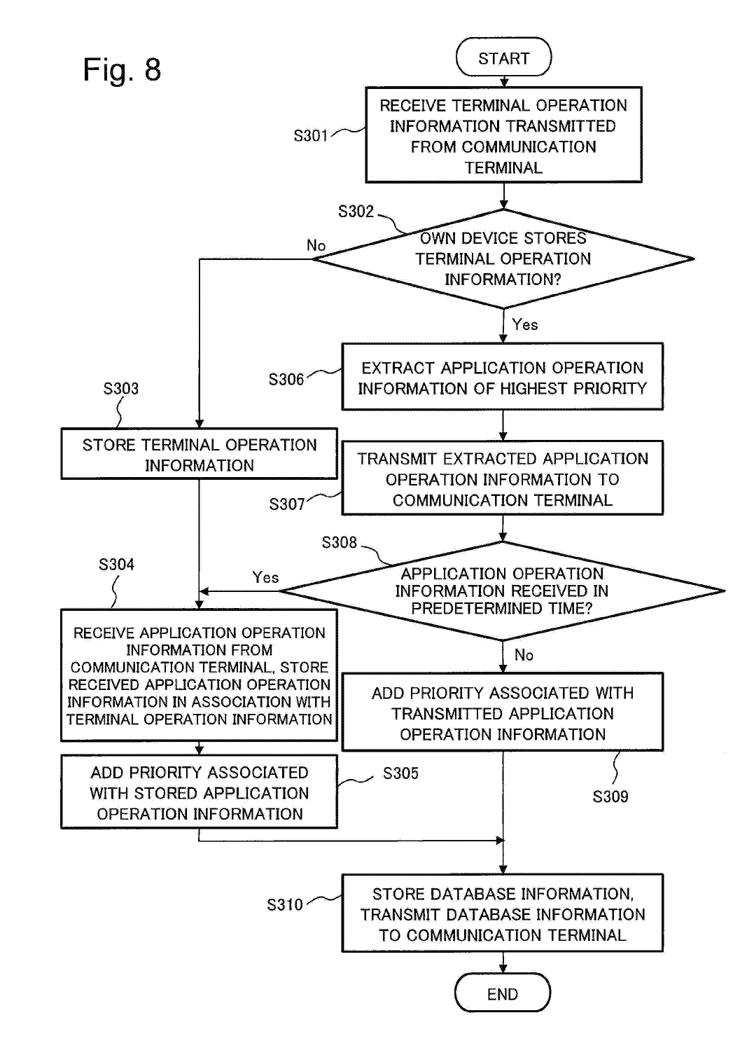

Next, an operation of the server 20 is described referring to the flowchart of FIG. 8. Note that the server 20 functions when the communication terminal 10 is within a communication range with respect to the server 20.

First of all, the terminal operation information receiving means 211 receives terminal operation information transmitted from the communication terminal 10 (Step S301).

In this example, the server 20 performs different operations depending on whether or not received terminal operation information is stored in the own device (server 20) (Step S302).

Firstly, a case is described, in which the server 20 does not store received terminal operation information (No in Step S302). The terminal operation information receiving means 211 collects terminal operation information (Step S303).

The application operation information receiving means 221 receives application operation information as operation information by the user within the application from the communication terminal 10, and stores the received application operation information in association with terminal operation information (Step S304).

The application operation priority adding means 223 adds an application operation priority of a stored application operation (Step S305). In this stage, database information including terminal operation information, application operation information, and an application operation priority is in a latest state.

After Step S305, the database information transmitting means 241 stores database information in a latest state and transmits the stored database information to the communication terminal 10 (Step S310).

Secondly, a case is described, in which terminal operation information is stored in the own device (Yes in Step S302). The application operation information extracting means 222 extracts application operation information whose application operation priority is highest regarding activation locations and activation times of applications, while using the application names as a key (Step S306).

The application operation information notifying means 224 transmits application operation information extracted by the application operation extracting means 222 to the communication terminal 10 (Step S307).

In this example, the server 20 performs different operations depending on whether or not the application is operated within a predetermined period of time after automatic application control is executed (Step S308).

When the application is not operated within a predetermined period of time (No in Step S308), the application operation priority adding means 223 adds an application operation priority of extracted application operation information (Step S309).

After Step S309, the database information transmitting means 241 stores database information in a latest state and transmits the stored database information to the communication terminal 10 (Step S310).

On the other hand, when the application is operated within a predetermined period of time (Yes in Step S308), the flow proceeds to Step S304. Specifically, the application operation information receiving means 221 receives application operation information from the communication terminal 10, and stores the received application operation information in association with terminal operation information (Step S304).

Then, the application operation priority adding means 223 adds an application operation priority of associated application operation information (Step S305).

After Step S305, the database information transmitting means 241 stores database information in a latest state and transmits the stored database information to the communication terminal 10 (Step S310).

The foregoing is a description about an operation of the server 20 when the communication terminal 10 of the automatic application control system 1 according to the example embodiment is outside a communication range with respect to the server 20.

In this example, a relationship of operations between the communication terminal 10 and the server 20 is described in detail using the sequence diagrams of FIG. 9 to FIG. 12. Note that the description using the sequence diagrams of FIG. 9 to FIG. 12 may partially overlap the description relating to the flowcharts of FIG. 6 to FIG. 8. Further, in the following description, the communication terminal 10 and the server 20 are described as subjects of each of the operations.

FIG. 9 illustrates an example, in which the communication terminal 10 and the server 20 are in a communicable state, and terminal operation information collected by the communication terminal 10 is not registered in the server 20.

In FIG. 9, first of all, the communication terminal 10 collects terminal operation information of an activated application (Step S401), and transmits the collected terminal operation information to the server 20 (Step S402).

When the server 20 receives terminal operation information (Step S403), the server 20 stores the received terminal operation information (Step S404).

In this example, in FIG. 9, terminal operation information collected by the communication terminal 10 is not registered in the server 20. Therefore, the communication terminal 10 collects application operation information of target communication terminal information (Step S405), and transmits the collected application operation information to the server 20 (Step S406). Note that when the server 20 does not store application operation information of received terminal operation information in the own device, the server 20 may send a request for transmitting associated application operation information to the communication terminal 10, which transmits terminal operation information.

When the server 20 receives application operation information, the server 20 stores the received application operation information in association with terminal operation information (Step S407). Then, the server 20 adds an application operation priority of application operation information (Step S408). The server 20 stores database information including terminal operation information, application operation information, and an application operation priority of the target application (Step S409), and transmits the stored database information to the communication terminal 10 (Step S410).

The communication terminal 10 receives and stores database information (Step S411).

The foregoing is a description about an operation of the automatic application control system 1 according to the example embodiment when the communication terminal 10 and the server 20 are in a communicable state, and terminal operation information collected by the communication terminal 10 is not registered in the server 20.

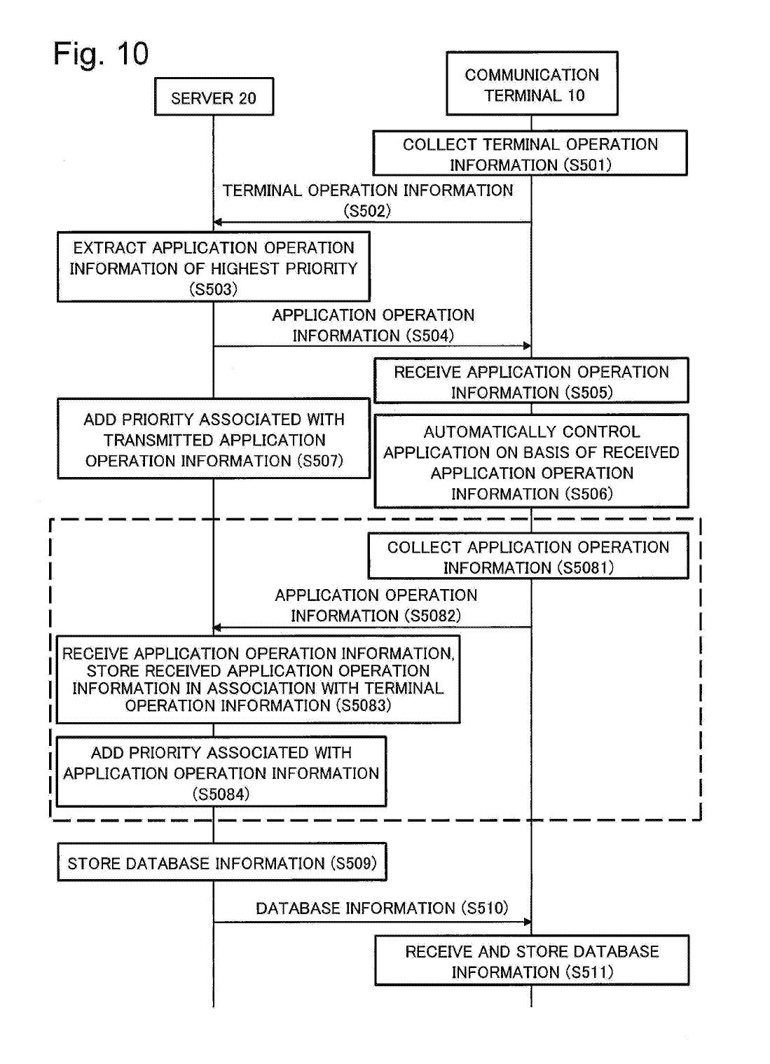

FIG. 10 illustrates an example, in which the communication terminal 10 and the server 20 are in a communicable state, and terminal operation information collected by the communication terminal 10 is registered in the server 20.

In FIG. 10, first of all, the communication terminal 10 collects terminal operation information of an activated application (Step S501), and transmits the collected terminal operation information to the server 20 (Step S502).

When the server 20 receives terminal operation information, the server 20 extracts application operation information which is associated with the received terminal operation information and whose application operation priority is highest (Step S503), and transmits the extracted application operation information to the communication terminal 10 (Step S504).

When the communication terminal 10 receives application operation information (Step S505), the communication terminal 10 automatically controls the application on the basis of the received application operation information (Step S506).

After Step S502, the server 20 adds an application operation priority of transmitted application operation information (Step S507). Note that before Step S504, the process of Step S507 may be performed.

In this example, after Step S506, a step which is necessary or not necessary is generated as a result of the presence or absence of a change in application operation information within a predetermined period of time, specifically, as a result of the presence or absence of transmitting or receiving application operation information.

When application operation information is transmitted or received within a predetermined period of time, the steps surrounded by the broken-line frame in FIG. 10 are necessary. Specifically, the communication terminal 10 collects application operation information (Step S5081), and transmits the collected application operation information to the server 20 (Step S5082). When the server 20 receives application operation information, the server 20 stores the received application operation information in association with terminal operation information (Step S5083). Then, the server 20 adds an application operation priority of application operation information (Step S5084).

After Step S5084, the server 20 stores database information including terminal operation information, application operation information, and an application operation priority of the target application (Step S509).

The serer 20 transmits stored database information to the communication terminal 10 (Step S510).

On the other hand, when application operation information is not transmitted or received within a predetermined period of time, the steps surrounded by the broken-line frame in FIG. 10 are not necessary. Specifically, after Step S507, the server 20 stores database information including terminal operation information, application operation information, and an application operation priority of the target application (Step S509). Then, the server 20 transmits stored database information to the communication terminal 10 (Step S510).

After Step S510, the communication terminal 10 receives database information from the server 20 and stores the received database information (Step S511).

The foregoing is a description about an operation of the automatic application control system 1 according to the example embodiment when the communication terminal 10 and the server 20 are in a communicable state, and terminal operation information collected by the communication terminal 10 is registered in the server 20.

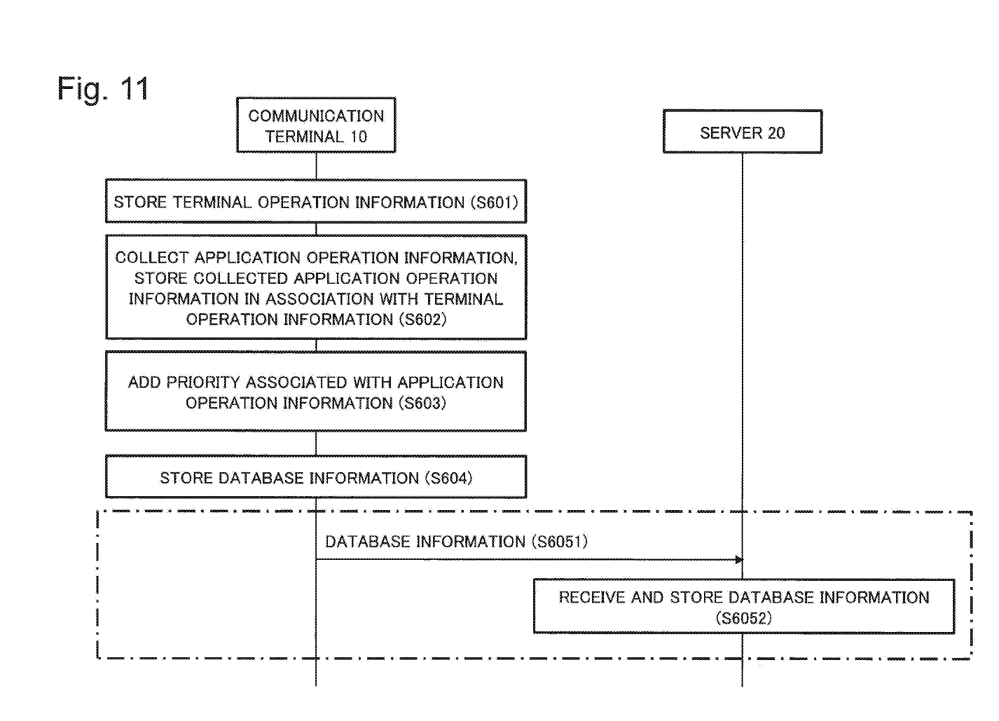

FIG. 11 illustrates an example, in which the communication terminal 10 and the server 20 are outside a communication range, and terminal operation information is not stored in the communication terminal 10.

In FIG. 11, first of all, the communication terminal 10 stores terminal operation information (Step S601), collects application operation information associated with the terminal operation information, and stores the collected application operation information in association with the terminal operation information (Step S602). The communication terminal 10 adds an application operation priority of stored application operation information (Step S603).

The communication terminal 10 stores database information including terminal operation information, application operation information, and an application operation priority of the target application (Step S604).

In this example, when the communication terminal 10 and the server 20 are still outside the communication range, the process of FIG. 11 is terminated. On the other hand, when the communication terminal 10 and the server 20 are communicable with each other, the process surrounded by the frame indicated by one-dotted chain line in FIG. 11 is executed. Specifically, the communication terminal 10 transmits database information to the server 20 (Step S6051). Then, the server 20 receives and stores database information (Step S6052).

The foregoing is a description about an operation of the automatic application control system 1 according to the example embodiment when the communication terminal 10 and the server 20 are outside a communication range, and terminal operation information is not stored in the communication terminal 10.

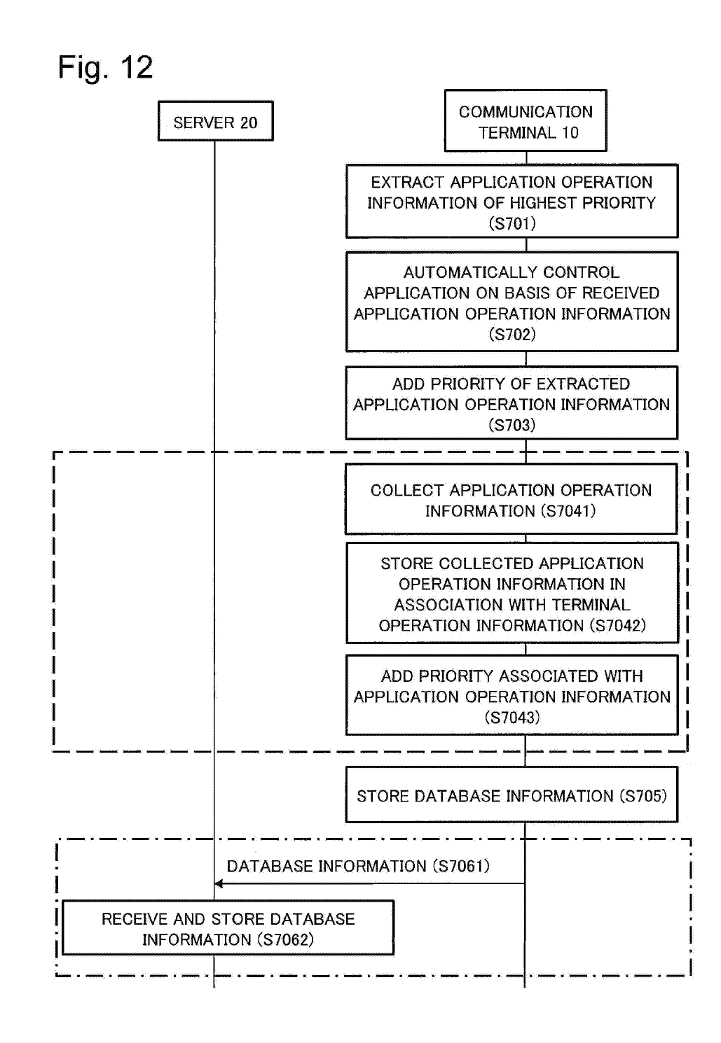

FIG. 12 illustrates an example, in which the communication terminal 10 and the server 20 are outside a communication range, and terminal operation information is stored in the communication terminal 10.

In FIG. 12, the communication terminal 10 extracts application operation information which is associated with terminal operation information of an activated application and whose application operation priority is highest (Step S701). The communication terminal 10 automatically controls the application on the basis of received application operation information (Step S702). The communication terminal 10 adds an application operation priority of extracted application operation information (Step S703).

In this example, after Step S703, a step which is necessary or not necessary is generated as a result of the presence or absence of a change in application operation information within a predetermined period of time, specifically, as a result of the presence or absence of transmitting or receiving application operation information.

When application operation information is transmitted or received within a predetermined period of time, the steps surrounded by the broken-line frame in FIG. 12 are necessary. Specifically, after Step S703, the communication terminal 10 collects application operation information (Step S7041), and stores the collected application operation information in association with terminal operation information (Step S7042). Then, the communication terminal 10 adds an application operation priority of collected application operation information (Step S7043). Then, the communication terminal 10 stores database information including terminal operation information, application operation information, and an application operation priority of the target application (Step S705).

On the other hand, when application operation information is not transmitted or received within a predetermined period of time, the steps surrounded by the broken line frame in FIG. 12 are not necessary. Specifically, after Step S703, the communication terminal 10 stores database information including terminal operation information, application operation information, and an application operation priority of the target application (Step S705).

In this example, when the communication terminal 10 and the server 20 are still outside a communication range, the process of FIG. 12 is terminated. On the other hand, when the communication terminal 10 and the server 20 are communicable with each other, the process surrounded by the frame indicated by one-dotted chain line in FIG. 12 is executed. Specifically, the communication terminal 10 transmits database information to the server 20 (Step S7061). Then, the server 20 receives and stores database information (Step S7062).

The foregoing is a description about an operation of the automatic application control system 1 according to the example embodiment when the communication terminal 10 and the server 20 are outside a communication range, and terminal operation information is stored in the communication terminal 10.

(Advantageous Effects)

As described above, according to the method of the example embodiment, it is possible to automatically control an application on the basis of an activation time, an activation location, and an application setting priority of each of the applications stored in a server or in a communication terminal depending on a surrounding environment in which an application is activated. Therefore, the user does not have to set an application each time depending on a surrounding environment. This prevents the user from erroneously setting an application or inadvertently forgetting to set an application.

According to the method of the example embodiment, a communication terminal and a server are provided with application operation information processing functions substantially equivalent to each other. Therefore, it is possible to execute automatic application control regardless of whether or not a communication terminal and a server are communicable with each other. Thus, according to the method of the example embodiment, when a communication terminal is within a communication range with respect to a server, it is possible to suppress electric power consumption of the communication terminal by causing the server to perform a process.

(Hardware Configuration)

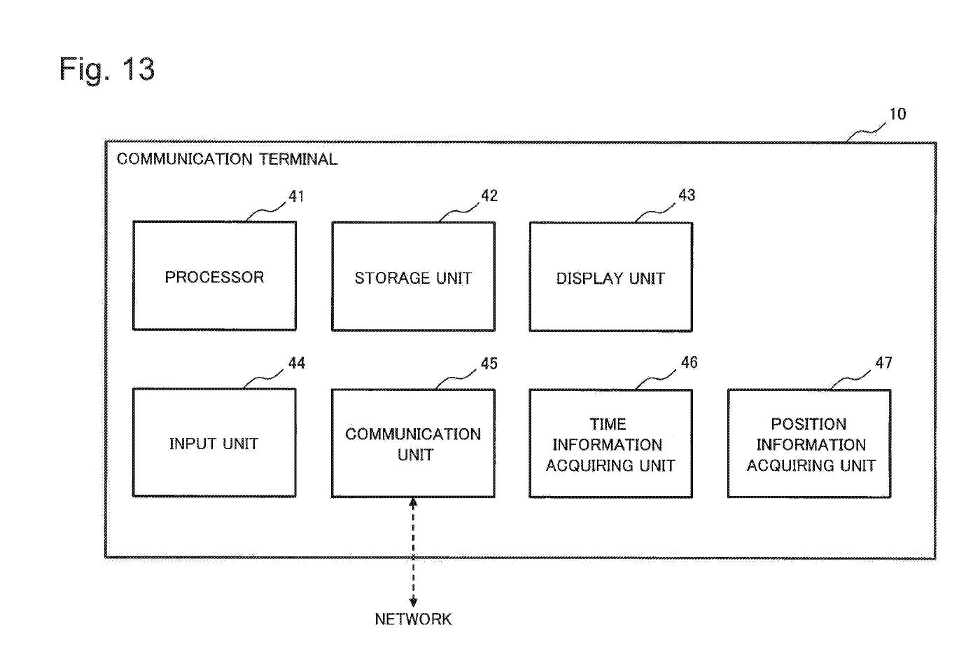

Next, a hardware configuration of the communication terminal 10 is briefly described using FIG. 13. The communication terminal 10 is a terminal device having a general communication function. For instance, the communication terminal 10 is implemented by a mobile phone, a smartphone, a notebook PC (Personal Compute), a desktop PC, a PDA (Personal Digital Assistant), a tablet computer, or the like. Note that the communication terminal 10 is not limited to the aforementioned devices. Further, the communication terminal 10 may preferably be a device having a wireless communication function.

As illustrated in FIG. 13, the communication terminal 10 includes a communication unit 45 to be connected to a network 30 for communicating with the server 20. The communication unit 45 includes an antenna compatible with wireless standards to be used, transmitting and receiving functions for transmitting and receiving a wireless signal, a signal processing function for processing a received wireless signal, and the like. Note that when the communication unit 46 of the communication terminal 10 is in an environment connectable to a network via a cable through a port, the communication unit 45 may not necessarily have a wireless function.

Further, the communication terminal 10 includes a processor 41 having a calculation function for processing information and a control function for controlling each of the means, a storage unit 42 capable of configuring a database for storing data, and a display unit 43 for displaying information. The storage unit 42 is implemented by, for instance, a main storage device such as a memory, an auxiliary storage device such as a hard disk, or a storage medium such as a memory card. The processor 41 is implemented by, for instance, a calculation function or a control function of a CPU (Central Processing Unit). Further, the communication terminal 10 includes an input unit 44 for inputting information. The input unit 44 is implemented by, for instance, an input key, a touch panel, or a keyboard.

Further, the communication terminal 10 includes a time information acquiring unit 46 for acquiring and measuring time information, and a position information acquiring unit 47 for acquiring position information. Time information may be a time measured by a clock function of the communication terminal 10, a time to be acquired by the function of a radio clock, or a time to be acquired via the network 30. Specifically, the time information acquiring means 46 is implemented by a clock function of the communication terminal 10 or by a function for acquiring a point of time from the outside.

The position information acquiring unit 47 is implemented by a device having a GPS (Global Positioning System) function, for example. Further, the position information acquiring unit 47 may acquire position information by using position information or the like acquired from a base station to be wirelessly connected, from an access point, or from the network 30, for example. Furthermore, the position information acquiring unit 47 may use position information to be measured by a gyro sensor or a magnetic sensor within the communication terminal 10 on the basis of position information acquired at a specific point of time. For instance, when position information is acquired by a GPS or the like, position information of the communication terminal 10 may be associated with specific facility information or the like by software for mapping acquired position information on a map.

Further, for instance, incorporating an acceleration sensor or a magnetic sensor in the communication terminal 10, and analyzing speed information measured by the sensor incorporated in the communication terminal 10 and position information acquired from a GPS make it possible to determine that the communication terminal 10 is in a moving body such as a train or an automobile. For instance, when the communication terminal 10 is in a moving body, it is possible to specify in what moving body the communication terminal 10 is by software for analyzing position information of the communication terminal 10 to be acquired by a GPS, and speed information of the communication terminal 10 to be acquired by a sensor.

Further, for instance, it is also possible to specify position information indicating the presence of the connected communication terminal 10 by an access point of a wireless LAN (Local Area Network) in a building or in a moving body. For instance, associating an identification number such as an IP (Internet Protocol) address set for a device as an access point with position information makes it possible to specify a location where the communication terminal 10 is connected to a network by the IP address.

The foregoing is a description about a hardware configuration for implementing the communication terminal 10.

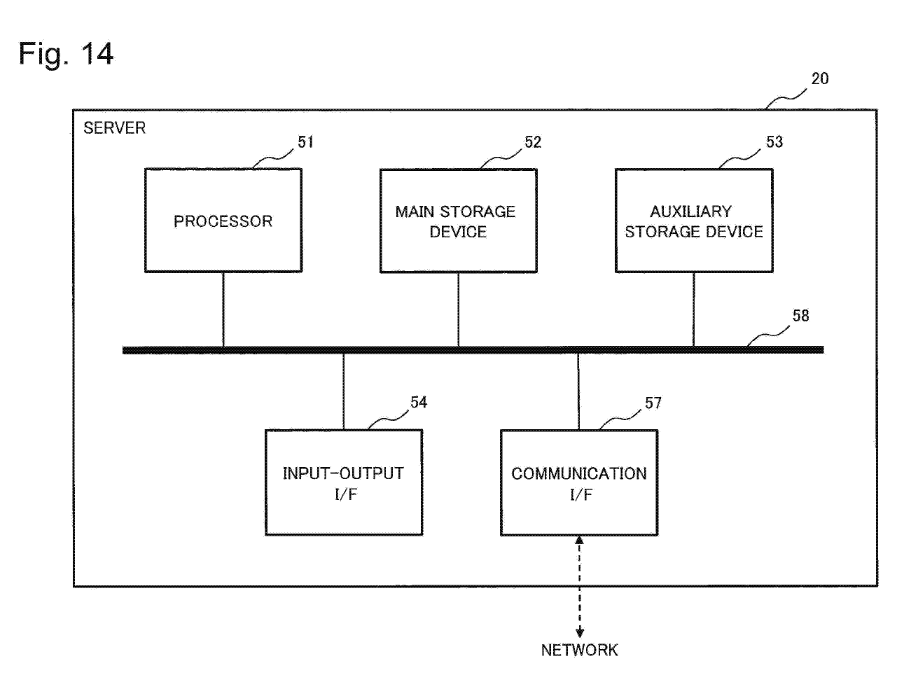

Next, a hardware configuration of the server 20 is briefly described using FIG. 14.

As illustrated in FIG. 14, the server 20 includes a processor 51, a main storage device 52, an auxiliary storage device 53, an input-output interface 54, and a communication interface 57. The processor 51, the main storage device 52, the auxiliary storage device 53, the input-output interface 54, and the communication interface 57 are connected in such a manner that data is transmittable and receivable via a bus 58. Further, the processor 51, the main storage device 52, the auxiliary storage device 53, and the input-output interface 54 are connected to the network 30 via the communication interface 57.

The processor 51 decompresses a program stored in the auxiliary storage device 53 or the like on the main storage device 52, and runs the decompressed program. Note that in the example embodiment, the processor 51 may be configured to use a software program installed in the server 20. Further, the processor 51 may also be configured to use a software program stored in a storage or the like accessible via the network 30.

The main storage device 52 may be a volatile memory such as a DRAM (Dynamic Random Access Memory). Further, a non-volatile memory such as an MRAM (Magnetoresistive Random Access Memory) may be configured as the main storage device 52, or may be added to the main storage device 52. A program is decompressed on the main storage device 52.

The auxiliary storage device 53 is configured by a local disk such as a hard disk or a flash memory. Note that the auxiliary storage device 53 may be an external storage device connected to the server 20, or may be a network storage connected via the network 30.

The input-output interface 54 is a device for connecting between the server 20 and a peripheral device on the basis of connection standards between the server 20 and the peripheral device.

The communication interface 57 is a device for mediating data transmitting and receiving between the communication terminal 10 and the processor 51 connected via the network 30.

Further, the server 20 may include an input device such as a keyboard, a mouse, or a touch panel, as necessary. An input device is used for using in inputting information or settings. Note that when a touch panel is used as an input device, a display device is configured to also serve as the input device. Data transmitting and receiving between the processor 51 and an input device may be mediated by the input-output interface 54.

Further, the server 20 may include a display device for displaying information, as necessary. When a display device is included, the server 20 may include a display control device (not illustrated) for controlling display of the display device. An unillustrated display device may be connected via the input-output interface 54.

Further, the server 20 includes a reader/writer, as necessary. A reader/writer is connected to the bus 58, mediates data transmitting and receiving between the processor 51 and an unillustrated recording medium (a program recording medium), reads data and a program from the recording medium, and writes a processing result of the server 20 in the recording medium. A recording medium may be implemented by a semiconductor recording medium such as an SD (Secure Digital) card. Further, a recording medium 516 may be implemented by a magnetic recording medium such as a flexible disk, or an optical recording medium such as a CD (Compact Disk) or a DVD (Digital Versatile Disc).

The foregoing is an example of a hardware configuration for implementing the server 20 according to the example embodiment of the present invention.

Note that the hardware configuration illustrated in FIG. 13 and FIG. 14 is an example of a hardware configuration for implementing the communication terminal 10 and the server 20 of the automatic application control system according to the example embodiment, and does not limit the scope of the present invention. Further, an automatic application control program which causes a computer to execute the process of the automatic application control system according to the example embodiment is also included in the scope of the present invention. Furthermore, a program recording medium recording the automatic application control program according to the example embodiment of the present invention is also included in the scope of the present invention.

The present invention has been described as above referring to the example embodiment. The present invention, however, is not limited to the aforementioned example embodiment. The configuration and the details of the present invention may be modified in various ways comprehensible to a person skilled in the art within the scope of the present invention.

This application claims the priority based on Japanese Patent Application No. 2014-097601 filed on May 9, 2014, and all of the disclosure of which is hereby incorporated.

### REFERENCE SIGNS LIST

1 Automatic application control system

10 Communication terminal

11 Terminal operation information processing means

12 Application operation information processing means

13 Application control means

14 Database

20 Server

21 Terminal operation information acquiring means

22 Application operation information processing means

24 Database

30 Network

41 Processor

42 Storage unit

43 Display unit

44 Input unit

45 Communication unit

46 Time information acquiring unit

47 Position information acquiring unit

51 Processor

52 Main storage device

53 Auxiliary storage device

54 Input-output interface

57 Communication interface

58 Bus

111 Terminal operation information collecting means

112 Terminal operation information transmitting means

121 Application operation information collecting means

122 Application operation information extracting means

123 Application operation priority adding means

124 Application operation information transmitting means

131 Application control information receiving means

132 Automatic application control means

141 Database information transmitting means

142 Database information receiving means

211 Terminal operation information receiving means

221 Application operation information receiving means

222 Application operation information extracting means

223 Application operation priority adding means

224 Application operation information notifying means

241 Database information transmitting means

242 Database information receiving means

1. An automatic application control system comprising a communication terminal that comprises:
a terminal operation information processing circuitry that collects and stores terminal operation information including an application name of an activated application and surrounding environment information including an activation time and an activation location;
a first application operation information processing circuitry that acquires application operation information of the application, and stores the acquired application operation information and the terminal operation information in association with each other; and
an application control circuitry that acquires the application operation information associated with the terminal operation information of the activated application, and performs setting of the application on the basis of the acquired application operation information.

2. The automatic application control system according to claim 1, further comprising a server communicable with the communication terminal,
the server including:
a terminal operation information acquiring circuitry that stores, when the terminal operation information is not stored in the server in receiving the terminal operation information from the communication terminal, the received terminal operation information; and
a second application operation information processing circuitry that acquires the application operation information associated with the received terminal operation information, stores the acquired application operation information and the terminal operation information in association with each other, and when the terminal operation information is stored in the server, transmits the application operation information associated with the terminal operation information to be stored to the communication terminal.

3. The automatic application control system according to claim 2, wherein
when a plurality of the application operation information items are stored in association with the terminal operation information,
the first application operation information processing circuitry and the second application operation information processing circuitry set an application operation priority as a priority with respect to each of the plurality of application operation information items, and extract the application operation information associated with the terminal operation information on the basis of the application operation priority.

4. The automatic application control system according to claim 3, wherein
the communication terminal includes
a first database that stores database information including the terminal operation information, the application operation information, and the application operation priority, and
the server includes
a second database that stores the database information.

5. The automatic application control system according to claim 4, wherein
the communication terminal collects the terminal operation information when the application is activated,
when the communication terminal is within a communication range with respect to the server,
the communication terminal transmits the collected terminal operation information to the server,
the communication terminal receives the application operation information associated with the transmitted terminal operation information from the server, and sets the application on the basis of the received application operation information when the transmitted terminal operation information is stored in the server,
the communication terminal collects the application information associated with the transmitted terminal operation information, transmits the collected application operation information to the server, and receives the database information based on the transmitted application operation information from the server when the transmitted terminal operation information is not stored in the server, and
when the communication terminal is outside the communication range with respect to the server,
the communication terminal stores the collected terminal operation information, and the application operation information associated with the terminal operation information, and adds the application operation priority associated with the stored application operation information when the collected terminal operation information is not stored in the server, and
the communication terminal extracts the application operation information whose application operation priority is highest, and sets the application on the basis of the extracted application operation information when the collected terminal operation information is stored in the server.

6. The automatic application control system according to claim 5, wherein
the first application operation information processing circuitry adds the application operation priority of the associated application operation information when the application is operated within a predetermined period of time after the application control circuitry sets the application, and
the first database updates the database information including the application operation information in which the application operation priority is added.

7. The automatic application control system according to claim 6, wherein
when the terminal operation information is received from the communication terminal,
the server stores the received terminal operation information, receives the application operation information associated with the stored terminal operation information from the communication terminal, and adds the application operation priority associated with the received application operation information when the received terminal operation information is not stored in the server, and
the server extracts the application operation information whose application operation priority is highest, and transmits the extracted application operation information to the communication terminal when the received terminal operation information is stored in the server.

8. The automatic application control system according to claim 7, wherein
the second application operation information processing circuitry adds the application operation priority of the associated application operation information when the application is operated within a predetermined period of time after the application control circuitry sets the application, and
the second database updates the database information including the application operation information in which the application operation priority is added.

9. An automatic application control method comprising:
collecting terminal operation information including an application name of an activated application and surrounding environment information including an activation time and an activation location;
acquiring application operation information of the application;
storing the acquired application operation information and the terminal operation information in association with each other;
acquiring the application operation information associated with the terminal operation information of the activated application; and
performing setting of the application on the basis of the acquired application operation information.

10. A program recording medium recording an automatic application control program that causes a computer to execute:
a process of collecting terminal operation information including an application name of an activated application and surrounding environment information including an application name of an activated application, an activation time, and an activation location;
a process of acquiring application operation information of the application;
a process of storing the acquired application operation information and the terminal operation information in association with each other;
a process of acquiring the application operation information associated with the terminal operation information of the activated application; and
a process of performing setting of the application on the basis of the acquired application operation information.
